(19) United States
(12) Patent Application Publication
(10) Pub. No.: US 2002/0111465 A1
(43) Pub. Date: Aug. 15, 2002

(54) Pigment preparations

(76) Inventors: Frank Linke, Koln (DE); Kent Faubion, Charleston, SC (US); Udo Herrmann, Dormagen (DE)

Correspondence Address: BAYER CORPORATION, PATENT DEPARTMENT, 100 BAYER ROAD, PITTSBURGH, PA, 15205, US

(21) Appl. No.: 09/907,161

(22) Filed: Jul. 17, 2001

(30) Foreign Application Priority Data
Jul. 21, 2000 (DE) 10035494.7

(51) Int. Cl. C09B 45/00

(52) U.S. Cl. 534/703

(57) ABSTRACT

The invention relates to solid pigment preparations containing

(a) as pigment at least one metal complex of an azo compound that in the form of its tautomeric structures conforms to the formula (I)

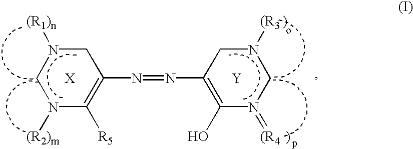

wherein

the X and Y rings independently are optionally substituted,

the dotted lines in the rings X and Y optionally represent double bonds such that the total number of endo- and exocyclic double bonds is three for each of the X and Y rings,

R₁, R₂, R₃, and R₄ are independently hydrogen, alkyl, cycloalkyl, aryl, or aralkyl, or R₁ and R₂ together and/or R₃ and R₄ together form 5- or 6-membered rings,

m, n, o, and p are 1 when the corresponding ring nitrogen atom is not part of a double bond or zero when the corresponding ring nitrogen atom is part of a double bond,

R₆ is hydrogen, alkyl, cycloalkyl, aryl, or aralkyl,

R₇ is hydrogen, cyano, alkyl, cycloalkyl, aryl, aralkyl, or acyl,

R₈ is alkyl, cycloalkyl, aryl, or aralkyl,

R₅ is —OH, —NR₆R₇, alkyl, cycloalkyl, aryl, or aralkyl,

wherein R₁ to R₈ are optionally further substituted, and

(b) at least one guest compound,

wherein the metal complex that contains at least 30 ppm of Fe, based on the sum total of metal complex and guest compound.

### BACKGROUND OF THE INVENTION

The invention relates to novel pigment preparations, processes for their production, and their use.

EP-A-73,463 and EP-A 994,164 disclose coloristically valuable pigments. However, their range of uses is limited, since changes to the properties can be achieved only by means of costly aftertreatments such as heating, grinding, or coating.

It is accordingly an object of the present invention to provide novel pigmentary forms that are free of the above-described disadvantages.

### SUMMARY OF THE INVENTION

According to the invention there are provided solid pigment preparations comprising

(a) as pigment at least one metal complex of an azo compound that in the form of its tautomeric structures conforms to the formula (I)

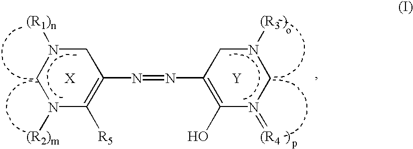

wherein

the X and Y rings independently are optionally substituted with one or two substituents selected from the group consisting of ═O, ═S, ═NR₇, —NR₆H₇, —OR₆, —SR₆, —COOR₆, —CN, —CONR₆R₇, —SO₂R₈,

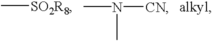

cycloalkyl, aryl, and aralkyl,

the dotted lines in each of the rings X and Y optionally represent one or two double bonds such that the total number of endo- and exocyclic double bonds is three for each of the X and Y rings,

R₁, R₂, R₃, and R₄ are independently hydrogen, alkyl, cycloalkyl, aryl, or aralkyl, or R₁ and R₂ together and/or R₃ and R₄ together form 5- or 6-membered rings, as indicated by the broken lines, to which further rings can optionally be fused,

m, n, o, and p are 1 when the corresponding ring nitrogen atom is not part of a double bond or are zero when the corresponding ring nitrogen atom is part of a double bond, as indicated by the dotted lines,

R₆ is hydrogen, alkyl, cycloalkyl, aryl, or aralkyl,

R₇ is hydrogen, cyano, alkyl, cycloalkyl, aryl, aralkyl, or acyl,

R₈ is alkyl, cycloalkyl, aryl, or aralkyl,

R₅ is —OH, —NR₆R₇, alkyl, cycloalkyl, aryl, or aralkyl,

with the proviso that R₁ to R₈ are optionally further substituted by replacing the hydrogen atom of a CH group, and

(b) at least one guest compound,

wherein the metal complex that hosts at least one other compound contains at least 30 ppm of Fe, based on the sum total of metal complex and guest compound.

### DETAILED DESCRIPTION OF THE INVENTION

Preferred organic metal complexes are metal complexes of azo compounds that in the form of their free acid conform to one of the tautomeric forms of the formula (I) where the X ring represents a ring of the formulas

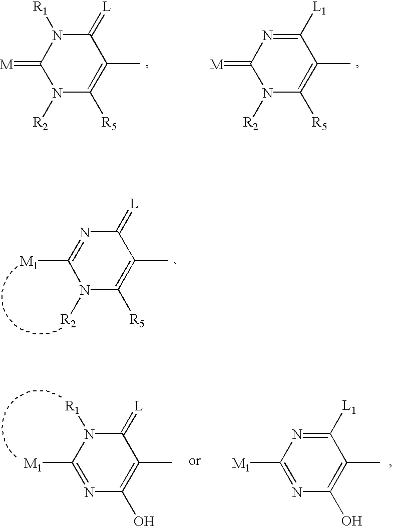

where

L and M are each independently ═O, ═S, or ═NR₆,

L₁ is hydrogen, —OR₆, —SR₆, —NR₆R₇, —COOR₆, —CONR₆R₇, —CN, alkyl, cycloalkyl, aryl, or aralkyl,

M₁ is —OR₆, —SR₆, —NR₆R₇, —COOR₆, —CONR₆R₇, —CN, —SO₂R₈,

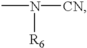

alkyl, cycloalkyl, aryl, or aralkyl, or the substituents M₁ and R₁ or M₁ and R₂ may form a 5- or 6-membered ring.

Particularly preferred organic metal complexes are those of azo compounds that in the form of their free acids conform to one of their tautomeric structures of the formulas (II) or (III)

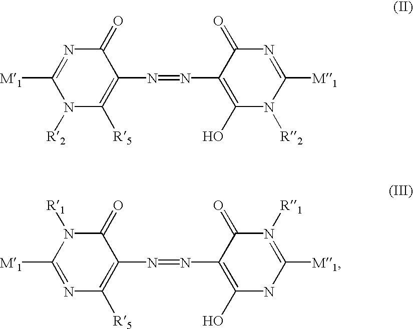

where

R′₅ is —OH or —NH₂,

R′₁, R″₁, R′₂, and R″₂ are each hydrogen, and

M′₁ and M″₁ are each independently hydrogen, —OH, —NH₂, —NHCN, arylamino, or acylamino.

Very particularly preferred metal complexes are those of azo compounds of the formula (I) that in the form of their free acid conform to one of the tautomeric structures of the formula (IV)

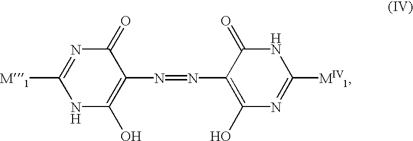

where M″′₁ and M^{IV}₁ are each independently OH or NHCN.

Preference is given especially to organic metal complexes of those azo compounds of the formula (I) that in the form of their free acid conform to one of the tautomeric structures of the formula (V)

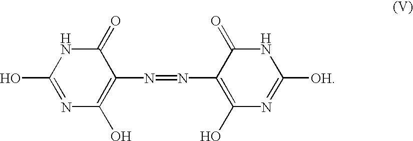

In the foregoing formulas, the substituents preferably have the following meanings:

Alkyl substituents are preferably C₁-C₆-alkyl, which may be substituted for example by halogen, such as chlorine, bromine or fluorine, —OH, —CN, —NH₂, or C₁-C₆-alkoxy.

Cycloalkyl substituents are preferably C₃-C₇-cycloalkyl, especially C₅-C₆-cycloalkyl, which may be substituted, for example, by C₁-C₆-alkyl, C₁-C₆-alkoxy, halogen such as Cl, Br, or F, C₁-C₆-alkoxy, —OH, —CN, or NH₂.

Aryl substituents are preferably phenyl or naphthyl, which may each be substituted for example by halogen such as F, Cl, or Br, —OH, C₁-C₆-alkyl, C₁-C₆-alkoxy, —NH₂, —NO₂, or —CN.

Aralkyl substituents are preferably phenyl- or naphthyl-C₁-C₄-alkyl, which may be substituted in the aromatic radicals by halogen such as F, Cl, or Br, —OH, C₁-C₆-alkyl, C₁-C₆-alkoxy, —NH₂, —NO₂, or —CN, for example.

Acyl substituents are preferably (C₁-C₆-alkyl)carbonyl, phenylcarbonyl, C₁-C₆-alkylsulfonyl, phenylsulfonyl, optionally C₁-C₆-alkyl-, phenyl-, or naphthyl-substituted carbamoyl, optionally C₁-C₆-alkyl-, phenyl-, or naphthyl-substituted sulfamoyl, or optionally C₁-C₆-alkyl-, phenyl-, or naphthyl-substituted guanyl, where the alkyl radicals may be substituted for example by halogen such as Cl, Br or F, —OH, —CN, —NH₂, or C₁-C₆-alkoxy and the phenyl and naphthyl radicals may be substituted, for example, by halogen such as F, Cl, or Br, —OH, C₁-C₆-alkyl, C₁-C₆-alkoxy, —NH₂, —NO₂, or —CN.

When M₁R₁ or M₁R₂ or M₁R₂ and R₁, R₂, R₃, R₄, as indicated by the broken lines in the formula (I), form 5- or 6-membered rings, these are preferably triazole, imidazole or benzimidazole, pyrimidine, or quinazoline ring systems.

Preferred pigment preparations are characterized in that the metal complex that hosts at least one other compound contains 30 to 2,000 ppm, especially 30 to 350 ppm, particularly preferably 50 to 350 ppm, of Fe, based on the sum total of metal complex and guest compound.

Preference is likewise given to those pigment preparations comprising at least two metal complexes of an azo compound that in the form of its tautomeric structure conforms to the formula (I) that each host at least one other compound, the metal of one of the metal complexes being Fe and the Fe content, based on the sum total of metal complexes, and guest compounds, being at least 30 ppm.

Preferably the guest compounds are the same for the two metal complexes.

Metal complexes, which is also to be understood as meaning metal salts, of the formulas (I) to (V) preferably include the salts and complexes of the mono-, di-, tri-, and tetraanions with the metals Li, Na, K, Mg, Ca, Ba, Fe, Co, Ni, Zn, Cu, Mn, Al, La, and Cr, particularly preferably Na, K, Ca, Ba, Ni, Zn, Cu, Mn, and La.

Particular preference is given to salts and complexes of the formulas (I) to (V) with di- or trivalent metals, very particularly the nickel salts and complexes.

The metal complexes that contain at least one other compound, especially an organic compound, as guest can be present as host-guest compounds, intercalation compounds, and also solid solutions.

The metal complexes are very particularly preferably inclusion compounds, intercalation compounds, and solid solutions in which the azobarbituric acid/nickel 1:1 complex conforms to one of the tautomeric forms of the formula

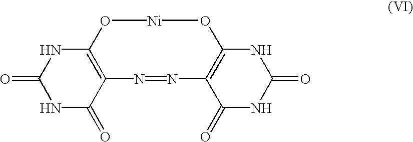

and includes at least one other compound.

In general, the metal complex forms a layered crystal lattice in which the bonding within a layer is essentially via hydrogen bonds and/or metal ions. Preferably, the metal complexes are metal complexes that form a crystal lattice that consists essentially of planar layers.

Useful metal complexes also include metal complexes in which a metal-containing compound, for example, a salt or metal complex, is incorporated into the crystal lattice of the nickel complex. In this case, in the formula (VI), for example, a portion of the nickel can be replaced by other metal ions or further metal ions can enter into a more or less pronounced interaction with the nickel complex.

Included compounds may be both organic compounds and inorganic compounds. Compounds that can be included come from a very wide variety of classes of compounds. For purely practical reasons, preference is given to compounds that are liquid or solid under normal conditions (25° C., 1 bar).

Of the liquid substances, preference is given in turn to those having a boiling point of 100° C. or higher, preferably of not less than 150° C., at 1 bar. Suitable compounds are preferably acyclic and cyclic organic compounds, for example, aliphatic and aromatic hydrocarbons, which may be substituted, for example by OH, COOH, NH₂, substituted NH₂, CONH₂, substituted CONH₂, SO₂NH₂, substituted SO₂NH₂, SO₃H, halogen, NO₂, CN, —SO₂-alkyl, —SO₂-aryl, —O-alkyl, —O-aryl, or —O-acyl.

Specific examples are paraffins and paraffin oils; triisobutylene, tetraisobutylene, mixtures of aliphatic and aromatic hydrocarbons such as produced in petroleum fractionation, for example; chlorinated paraffin hydrocarbons such as dodecyl chloride or stearyl chloride; C₁₀-C₃₀-alcohols such as 1-decanol, 1-dodecanol, 1-hexadecanol, 1-octadecanol, and their mixtures, olein alcohol, 1,12-octadecanediol, fatty acids and their salts and mixtures, for example, formic acid, acetic acid, dodecanoic acid, hexadecanoic acid, octadecanoic acid, oleic acid, fatty acid esters, for example, the methyl esters of C₁₀-C₂₀-fatty acids, fatty acid amides, such as stearamide, stearic acid monoethanolamide, stearic acid diethanolamide, stearonitrile, fatty amines, for example, dodecylamine, cetylamine, hexadecylamine, octadecylamine and others; salts of fatty amines with sulfonic and carboxylic acids, isocyclic hydrocarbons such as cyclodo-decane, decahydronaphthalene, o-, m-, p-xylene, mesitylene, dodecyl-benzene mixture, tetralin, naphthalene, 1-methylnaphthalene, 2-methylnaphthalene, biphenyl, diphenylmethane, acenaphthene, fluorene, anthracene, phenanthrene, m-, p-terphenyl, o-, p-dichlorobenzene, nitrobenzene, 1-chloronaphthalene, 2-chloronaphthalene, 1-nitronaphthalene, isocyclic alcohols and phenols and their derivatives such as benzyl alcohol, decahydro-2-naphthol, diphenyl ether, sulfones, for example, diphenyl sulfone, methyl phenyl sulfone, 4,4′-bis-2-(hydroxyethoxy)diphenyl sulfone; isocyclic carboxylic acids and their derivatives such as benzoic acid, 3-nitrobenzoic acid, cinnamic acid, 1-naphthalenecarboxylic acid, phthalic acid, dibutyl phthalate, dioctyl phthalate, tetrachlorophthalic acid, 2-nitrobenzamide, 3-nitrobenzamide, 4-nitrobenzamide, 4-chlorobenzamide, sulfonic acids, such as 2,5-dichlorobenzenesulfonic acid, 3-nitro-, 4-nitrobenzenesulfonic acid, 2,4-dimethylbenzenesulfonic acid, 1- and 2-naphthalenesulfonic acid, 5-nitro-1- and 5-nitro-2-naphthalenesulfonic acid, di-sec-butylnaphthalenesulfonic acid mixture, biphenyl-4-sulfonic acid, 1,4-, 1,5-, 2,6-, 2,7-naphthalenedisulfonic acid, 3-nitro-1,5-naphthalenedisulfonic acid, 1-anthraquinonesulfonic acid, 2-anthraquinonesulfonic acid, biphenyl-4,4′-disulfonic acid, 1,3,6-naphthalenetrisulfonic acid and the salts of these sulfonic acids, e.g., the sodium, potassium, calcium, zinc, nickel, and copper salts; sulfonamides such as benzenesulfonamide, 2-, 3- and 4-nitrobenzenesulfonamide, 2-, 3- and 4-chlorobenzenesulfonamide, 4-methoxybenzenesulfonamide, 3,3′-sulfonylbisbenzenesulfonamide, 4,4′-oxybisbenzenesulfonamide, and 1-and 2-naphthalenesulfonamide.

Carboxamides and sulfonamides are a preferred group of compounds to be included. Also suitable in particular are urea and substituted ureas such as phenylurea, dodecylurea, and others and also their polycondensates with aldehydes, especially formaldehyde; hetero-cycles such as barbituric acid, benzimidazolone, 5-benzimidazolone-sulfonic acid, 2,3-dihydroxyquinoxaline, 2,3-dihydroxyquinoxaline-6-sulfonic acid, carbazole, carbazole-3,6-disulfonic acid, 2-hydroxyquinoline, 2,4-dihydroxyquinoline, caprolactam, melamine, 6-phenyl-1,3,5-triazine-2,4-diamine, 6-methyl-1,3,5-triazine-2,4-diamine, and cyanuric acid.

Preferred metal complexes contain included surface-active compounds, especially surfactants, that are known, for example, from K. Lindner, Tenside-Textilhilfsmittel-Waschrohstoffe, 2nd edition, Volume I, Wissenschaftliche Verlagsgesellschaft mbH, Stuttgart, 1964. Suitable surface-active compounds can be anionic, nonionic, or cationic compounds or ampholytes. Examples of suitable anionic compounds are true soaps, salts of aminocarboxylic acids, salts of lower or higher acylated aminocarboxylic acids, fatty acid sulfates, sulfates of fatty acid esters, amides etc., primary alkyl sulfates, sulfates of oxo alcohols, secondary alkyl sulfates, sulfates of esterified or etherified polyoxy compounds, sulfates of substituted polyglycol ethers (sulfated ethylene oxide adducts), sulfates of acylated or alkylated alkanolamines, sulfonates of fatty acids, their esters, amides, etc., primary alkyl sulfonates, secondary alkyl sulfonates, alkyl sulfonates with acyls attached in ester fashion, alkyl or alkylphenyl ether sulfonates, sulfonates of polycarboxylic esters, alkylbenzenesulfonates, alkylnaphthalenesulfonates, fatty aromatic sulfonates, alkylbenzimidazolesulfonates, phosphates, polyphosphates, phosphonates, phosphinates, thiosulfates, hydrosulfites, sulfinates, and persulfates. Examples of suitable nonionic compounds are esters and ethers of polyalcohols, alkyl polyglycol ethers, acyl polyglycol ethers, alkylaryl polyglycol ethers, and acylated and alkylated alkanolamine polyglycol ethers. Examples of suitable cationic compounds are alkylamine salts, quaternary ammonium salts, alkylpyridinium salts, simple and quaternary imidazoline salts, alkyldiamines and alkylpolyamines, acyidiamines and acylpolyamines, acylalkanolamines, alkanolamine esters, alkyl-OCH₂-N-pyridinium salts, alkyl-CO-NH-CH₂-N-pyridinium salts, alkylethyleneureas, sulfonium compounds, phosphonium compounds, arsenium compounds, alkylguanidines, and acylbiguanidides. Examples of suitable ampholytes are alkylbetaines, sulfobetaines, and aminocarboxylic acids. Preference is given to using nonionic surfactants, especially the ethylene oxide addition products of fatty alcohols, fatty amines, and of octyl- or nonylphenol.

A further important group of guest compounds are natural resins and resin acids such as, for example, abietic acid and its conversion products and salts. Examples of such conversion products are hydrogenated, dehydrogenated, and disproportionated abietic acids. These can further be dimerized, polymerized, or modified by addition of maleic anhydride and fumaric acid. Also of interest are the resin acids modified at the carboxyl group such as, for example, the methyl, hydroxyethyl, glycol, glyceryl, and pentaerythritol esters and also resin acid nitriles and resin acid amines and also dehydroabietyl alcohol.

Also suitable for hosting are polymers, preferably water-soluble polymers, for example, ethylene-propylene oxide block polymers, preferably having an Mn not less than 1,000, especially of 1,000 to 10,000 g/mol, polyvinyl alcohol, poly(meth)acrylic acids, modified cellulose, such as carboxymethylcelluloses, hydroxyethyl- and -propylcelluloses, and methyl- and ethyl-hydroxyethylcelluloses.

Other suitable guest compounds are condensation products based on

(A) sulfonated aromatics,

(B) aldehydes and/or ketones, and optionally

(C) one or more compounds selected from the group of the non-sulfonated aromatics, urea, and urea derivatives.

Based on means that the condensation product was optionally prepared from other reactants besides (A), (B), and optionally (C). Preferably, however, the condensation products for the purposes of this invention are prepared only from (A), (B), and optionally (C).

The sulfonated aromatics of component (A) will be understood in the context of this invention as including sulfomethylated aromatics as well. Preferred sulfonated aromatics are naphthalenesulfonic acids, phenolsulfonic acids, dihydroxybenzenesulfonic acids, sulfonated ditolyl ethers, sulfomethylated 4,4′-dihydroxydiphenyl sulfone, sulfonated diphenylmethane, sulfonated biphenyl, sulfonated hydroxybiphenyl, especially 2-hydroxybiphenyl, sulfonated terphenyl, or benzenesulfonic acids.

Aldehydes and/or ketones useful as component (B) include in particular aliphatic, cycloaliphatic, and also aromatic aldehydes and/or ketones. Preference is given to aliphatic aldehydes, particularly preferably formaldehyde and other aliphatic aldehydes of 3 to 5 carbon atoms.

Examples of non-sulfonated aromatics useful as component (C) are phenol, cresol, 4,4′-dihydroxydiphenyl sulfone, and dihydroxydiphenylmethane.

Examples of urea derivatives are dimethylolurea, alkylureas, melamine, and guanidine.

Preference is given to using a condensation product based on

(A) at least one sulfonated aromatic selected from the group consisting of naphthalenesulfonic acids, phenolsulfonic acids, dihydroxybenzenesulfonic acids, sulfonated ditolyl ethers, sulfomethylated 4,4′-dihydroxydiphenyl sulfone, sulfonated diphenylmethane, sulfonated biphenyl, sulfonated hydroxybiphenyl, especially 2-hydroxybiphenyl, sulfonated terphenyl, and benzenesulfonic acids,

(B) formaldehyde, and optionally

(C) one or more compounds selected from the group consisting of phenol, cresol, 4,4′-dihydroxydiphenyl sulfone, dihydroxydiphenylmethane, urea, dimethylolurea, melamine, and guanidine.

Preferred condensation products are condensation products based on 4,4′-dihydroxydiphenyl sulfone, sulfonated ditolyl ether, and formaldehyde; 4,4′-dihydroxydiphenyl sulfone, phenolsulfonic acid, and formaldehyde; 4,4′-dihydroxydiphenyl sulfone, sodium bisulfite, formaldehyde, and urea; naphthalenesulfonic acid, 4,4′-dihydroxydiphenyl sulfone, and formaldehyde; sulfonated terphenyl, and formaldehyde; and/or sulfonated 2-hydroxybiphenyl and formaldehyde and also naphthalenesulfonic acid and formaldehyde.

Particular preference for use as guest compounds is given to melamine or melamine derivatives, especially those of the formula (VII)

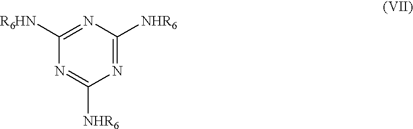

where

R₆ is hydrogen or C₁-C₄-alkyl, which is optionally substituted by OH groups, very particularly preferably where R₆ is hydrogen.

The amount of substance that can be incorporated as guest compounds in the crystal lattice of the metal compounds is generally 5% to 200% by weight, especially 5 to 120% by weight, based on the amount of host compound. Preference is given to a guest compound amount of 10 to 100% by weight. The amount referred to here is the amount of substance that cannot be washed out by suitable solvents and that is obtained from the elemental analysis. Naturally, it is also possible to add more or less than the aforementioned amount of substance, and it may be optionally dispensed with to wash an excess out. Preference is given to amounts of 10 to 150% by weight.

The pigment in the preparation of the invention preferably has a surface area (m²/g) of ≧150 m²/g, especially 150 to 250 m²/g.

The preparations of the invention may comprise further additives. Preferred additives are organic or inorganic bases.

Suitable bases are alkali metal hydroxides, for example, NaOH or KOH, or organic amines such as alkylamines, especially alkanolamines or alkylalkanolamines.

Particular preference is given to methylamine, dimethylamine, trimethylamine, ethanolamine, n-propanolamine, n-butanolamine, diethanolamine, triethanolamine, methylethanolamine, or dimethylethanolamine.

Examples of further additives are dispersants, carboxamides, sulfonamides, and also customary pigment preparation additives.

Dispersants for the purposes of the present invention are substances that stabilize the pigment particles in their fine particulate form in aqueous media. Finely particulate is preferably understood as meaning a fine division of 0.001 to 5 μm, especially of 0.005 to 1 μm, particularly preferably of 0.005 to 0.5 μm.

Suitable dispersants are for example anionic, cationic, amphoteric, or nonionic.

Suitable anionic dispersants are in particular condensation products of aromatic sulfonic acids with formaldehyde, such as condensation products of formaldehyde and alkylnaphthalenesulfonic acids or of formaldehyde, naphthalenesulfonic acids, and/or benzenesulfonic acids, and condensation products of optionally substituted phenol with formaldehyde and sodium bisulfite. Also suitable are dispersants from the group of the sulfosuccinic esters and alkylbenzenesulfonates, as well as sulfated, alkoxylated fatty acid alcohols or salts thereof. Alkoxylated fatty acid alcohols are to be understood as meaning in particular those C₆-C₂₂ fatty acid alcohols that are provided with 5 to 120, preferably 5 to 60, especially with 5 to 30, ethylene oxide and are saturated or unsaturated, especially stearyl alcohol. Particular preference is given to a stearyl alcohol alkoxylated with 8 to 10 ethylene oxide units. The sulfated alkoxylated fatty acid alcohols are preferably present as salts, especially as alkali metal or amine salts, preferably as diethylamine salt. Also suitable in particular are ligninsulfonates, for example those obtained by the sulfite or kraft process. Preferably they are products that are partially hydrolyzed, oxidized, propoxylated, sulfonated, sulfomethylated, or desulfonated and fractionated according to known processes, for example according to the molecular weight or according to the degree of sulfonation. Mixtures of sulfite and kraft ligninsulfonates are likewise very effective. Of particular suitability are ligninsulfonates having an average molecular weight between 1,000 and 100,000, an active ligninsulfonate content of not less than 80% and preferably a low level of polyvalent cations. The degree of sulfonation can vary widely.

Examples of useful nonionic dispersants are reaction products of alkylene oxides with alkylatable compounds, for example, fatty alcohols, fatty amines, fatty acids, phenols, alkylphenols, arylalkylphenols, such as styrene-phenol condensates, carboxamides, and resin acids. They are, for example, ethylene oxide adducts from the class of the reaction products of ethylene oxide with

(a1) saturated and/or unsaturated fatty alcohols of 6 to 22 carbon atoms or

(b1) alkylphenols having 4 to 12 carbon atoms in the alkyl radical or

(c1) saturated and/or unsaturated fatty amines of 14 to 20 carbon atoms or

(d1) saturated and/or unsaturated fatty acids of 14 to 20 carbon atoms or

(e1) hydrogenated or unhydrogenated resin acids.

Suitable ethylene oxide adducts are in particular the alkylatable compounds mentioned under (a1) to (e1) when combined with 5 to 120 mol (especially 5 to 100 mol, especially 5 to 60 mol, particularly preferably 5 to 30 mol) of ethylene oxide.

Suitable dispersants also include the esters of the alkoxylation product of the formula (X) known from DE-A 19 712 486, which has an earlier priority date, or from DE-A 19 535 246, which conform to the formula (XI) and also these optionally mixed together with the parent compounds of the formula (X). The alkoxylation product of a styrene-phenol condensate of the formula (X) is as defined below:

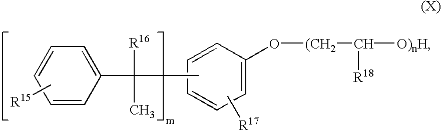

where

R¹⁵ is hydrogen or C₁-C₄-alkyl,

R¹⁶ is hydrogen or CH₃,

R¹⁷ is hydrogen, C₁-C₄-alkyl, C₁-C₄-alkoxy, C₁-C₄-alkoxycarbonyl or phenyl,

m is from 1 to 4,

n is from 6 to 120,

R¹⁸ is identical or different for each —(—CH₂—CH(R¹⁸)—O—)— unit and represents hydrogen, CH₃, or phenyl subject to the proviso that (i) when CH₃ is present in the various —(—CH₂—CH(R¹⁸)—O—)— groups, then 0 to 60% of the total R¹⁸ is CH₃ and 40 to 100% of the total R¹⁸ is hydrogen and (ii) when phenyl is present in the various —(—CH₂—CH(R₁₈)—O—)— groups, then 0 to 40% of the total R¹⁸ is phenyl and 60 to 100% of the total R¹⁸ is hydrogen.

Esters of alkoxylation products (X) conform to the formula (XI)

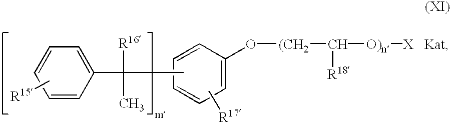

where

R¹⁵′, R¹⁶′, R¹⁷′, R¹⁸′, m′ and n′ assume the scope of meaning of R¹⁵, R¹⁶, R¹⁷, R¹⁸, m, and n, respectively, but independently thereof,

X is —SO₃—, —SO₂—, —PO₃═, or —CO—(R¹⁹)—COO—,

Kat is a cation selected from the group consisting of H⁺, Li⁺, Na⁺, K⁺, NH₄⁺, and HO—CH₂CH₂—NH₃⁺, subject to the proviso that when X is —PO₃═ two cations are present, and

R¹⁹ is a divalent aliphatic or aromatic radical, preferably C₁-C₄-alkylene, especially ethylene, monounsaturated C₂-C₄ radicals, especially acetylene, or optionally substituted phenylene, especially ortho-phenylene, preferred substituents being C₁-C₄-alkyl, C₁-C₄-alkoxy, C₁-C₄-alkoxycarbonyl, or phenyl.

Specific individual compounds of the formula (XI) are known, for example, from DE-A 19 712 486 and mixtures of the formulas (X) and (XI) for example from DE-A 19 535 256.

A preferred dispersant is the compound of the formula (XI), preferably a compound of the formula (XI) where X is a radical of the formula —CO—(R¹⁹)—COO— and R¹⁹ is as defined above.

Preference for use as dispersant is likewise given to a compound of the formula (XI) used together with a compound of the formula (X). In this case, the dispersant preferably contains 5 to 99% by weight of the compound (XI) and 1 to 95% by weight of the compound (X).

Polymeric dispersants are, for example, water-soluble and also water-emulsifiable compounds, for example, homopolymers and copolymers such as random or block copolymers.

Particularly preferred polymeric dispersants are for example AB, BAB, and ABC block copolymers. In the AB or BAB block copolymers, the A segment is a hydrophobic homopolymer or copolymer that provides a bond to the pigment and the B block is a hydrophilic homopolymer or copolymer or a salt thereof and ensures dispersal of the pigment in an aqueous medium. Such polymeric dispersants and their synthesis are known for example from EP-A 518,225 and EP-A 556,649.

The dispersant is preferably used in an amount of 0.1 to 100% by weight, especially 0.5 to 60% by weight, based on the pigment used in the pigment preparation.

Examples of suitable carboxamides and sulfonamides are urea and substituted ureas such as phenylurea, dodecylurea and others; hetero-cycles such as barbituric acid, benzimidazolone, benzimidazolone-5-sulfonic acid, 2,3-dihydroxyquinoxaline, 2,3-dihydroxyquinoxaline-6-sulfonic acid, carbazole, carbazole-3,6-disulfonic acid, 2-hydroxyquinoline, 2,4-dihydroxyquinoline, caprolactam, melamine, 6-phenyl-1,3,5-triazine-2,4-diamine, 6-methyl-1,3,5-triazine-2,4-diamine, and cyanuric acid.

The preparation of the invention preferably contains 80 to 100% by weight, especially 90 to 99.9% by weight, of the above pigment.

In a particularly preferred embodiment, the pigment preparations of the invention contain 30 to 99.9% by weight of at least one of the above pigments and 0 to 50% by weight of a dispersant, each based on the total amount of the preparation.

The preparation may contain further additives, of course. For instance, additives that reduce the viscosity of an aqueous suspension and increase the solids content, such as the above-mentioned carboxamides and sulfonamides, can be added in an amount of up to 10% by weight, based on the preparation.

However, it is particularly preferable for the preparation of the invention to contain more than 90%, especially more than 95%, preferably more than 97%, by weight of pigment and dispersant.

The invention further provides a process for producing the pigment preparation according to the invention by complexing the azo compounds of the formula (I) with a non-iron metal salt in the presence of an iron salt and reacting the resultant metal complex with the compound to be hosted, wherein the iron content is at least 30 ppm, based on the sum total of metal complex and guest compound.

A preferred process is characterized in that the azo compound of the formula (I), preferably as alkali metal salt such as Na, Li, or K salt, is reacted with a metal salt of metals selected from the group consisting of Li, Na, K, Mg, Ca, Ba, Fe, Co, Ni, Zn, Cu, Mn, Al, La, and Cr, particularly preferably Na, K, Ca, Ba, Ni, Zn, Cu, Mn, and La, in the presence of an iron salt, preferably at pH<7, and the resultant metal complex is reacted with the compound to be hosted, preferably at a pH of 1 to 7. A preferred embodiment of the process according to the invention is characterized by raising the pH to not less than 4.5 preferably to 4.5 to 7 after the formation of the host-guest compound, if the formation of the host-guest compound took place at a pH of less than 4.5.

The metal salt used is preferably selected from water-soluble metal salts of the above-mentioned metals, especially chlorides, bromides, acetates, nitrates, etc. Preferred metal salts have a solubility in water of more than 20 g/l, especially more than 50 g/l, at 20° C.

Useful metals salts for preparing the salts and complexes of the azo compounds include, for example, magnesium chloride, magnesium sulfate, calcium chloride, calcium acetate, calcium formate, barium chloride, barium nitrate, barium acetate, barium carbonate, strontium nitrate, manganese chloride, manganese sulfate, cobalt chloride, cobalt nitrate, cobalt sulfate, nickel formate, nickel nitrate, nickel sulfate, nickel chloride, nickel acetate, aluminum sulfate, aluminum nitrate, chromium(III) sulfate, chromium(III) nitrate, zinc chloride, zinc sulfate, zinc acetate, cadmium chloride, cadmium sulfate, cadmium nitrate, copper(II) sulfate, copper(II) chloride, copper(II) acetate and copper(II) formate, lanthanum nitrate, and aluminum chloride hydrate.

It is also possible to use mixtures of these salts that may contain various of the metals mentioned. The use of such salt mixtures is advisable in particular for obtaining intermediate hues of the colored end products.

Preferred iron salts include: iron(II) chloride, iron(II) sulfate, and also iron(III) chloride.

The pigments obtained in this way may then be isolated as aqueous presscake by filtration of their aqueous suspension. This presscake may, for example, after washing with hot water, be dried by customary drying processes.

Useful drying processes include, for example, paddle drying or the spray drying of appropriately aqueous slurries.

The pigment may then be supplementarily ground.

Pigments that are too harsh in texture for the desired use may be converted into soft-textured pigments, for example, by the method described in DE-A 19 847 586.

For the purposes of this invention, the metal complexes of an azo compound of the formula (I) that host at least one compound are referred to as pigments. The invention therefore also provides pigment preparations containing at least one pigment according to the invention and a dispersant.

The pigment preparations are preferably solid preparations, which are preferably present as powders or granules.

The pigments of the invention are notable for particularly good dispersibility and high color strength. They are also very finely divided.

The solid pigment preparations are very useful for all pigment applications.

They are useful for example for pigmenting varnishes of all kinds for the production of printing colors, distemper colors, or binder colors, for the mass coloration of synthetic, semisynthetic, or natural macromolecular substances, for example, polyvinyl chloride, polystyrene, polyamide, polyethylene, or polypropylene, and for the spin-dyeing of natural, regenerated, or artificial fibers, for example, cellulose, polyester, polycarbonate, polyacrylonitrile, or polyamide fibers, and also for printing textiles and paper. These pigments provide finely divided, stable, aqueous pigmentations of emulsion and paint colors that are useful for paper coloration, for the pigment printing of textiles, for laminating, and also for the spin-dyeing of viscose, by grinding or kneading in the presence of nonionic, anionic, or cationic surfactants.

The following examples further illustrate details for the preparation and use of the compositions of this invention. The invention, which is set forth in the foregoing disclosure, is not to be limited either in spirit or scope by these examples. Those skilled in the art will readily understand that known variations of the conditions and processes of the following preparative procedures can be used to prepare these compositions. Unless otherwise noted, all temperatures are degrees Celsius and all percentages are percentages by weight.

### EXAMPLES

### Examples 1-6

5 kg of a suspension of the potassium salt of azobarbituric acid (12.5% by weight) were admixed with 1,970 g of a solution of NiCl₂.6H₂0 (content=24.9% by weight). The solution of the iron salt was then added. 504 g of melamine were stirred in and made up to 10 liters with deionized water. With pronounced stirring, the suspension was heated to 98° C. and maintained at 98° C. for 4 hours.

The pH was then adjusted to 5 with KOH solution (5%), which was followed by suction filtration, washing, drying under reduced pressure and grinding in a laboratory mill. The pigment powder thus obtained was incorporated in a white melamine-alkyd paint according to DIN 53 238 Part 31 for calorimetric measurement.

| | | | Surface area | Color |
|---|---|---|---|---|
| Ex. No. | ppm of Fe/Addition | | (m²/g) | strength |
| 1 | 0 | | 106 | 100% |
| 2 | 25 | 0.145 g FeSO₄ · 7 H₂O | 140 | 114% |
| 3 | 50 | 0.29 g FeSO₄ · 7 H₂O | 153 | 118% |
| 4 | 75 | 0.435 g FeSO₄ · 7 H₂O | 138 | 120% |
| 5 | 100 | 0.58 g FeSO₄ · 7 H₂O | 170 | 135% |
| 6 | 1,000 | 5.8 g FeSO₄ · 7 H₂O | 145 | 116% |

### Example 7

0.07 mol of presscake (11.4%) of the potassium salt of cyanimino-azobarbituric acid was suspended in 800 ml of water, admixed with 0.1 mol of BaCl₂.2H₂O and 250 mg of FeCl₂.4H₂O, and subsequently stirred at 95° C. and pH 5.0 for 3 hours.

Then 0.2 mol of melamine was added at pH 2.5 and stirred in for 2 hours at the same temperature.

The batch was adjusted to pH 4.8 with 20% potassium acetate solution and filtered with suction, and the filter residue was washed with distilled water and dried. The product was dispersed in a white alkyd-melamine paint according to DIN 53 238 Part 31.

The specific surface area was 60 m²/g. The color strength was 120%, based on reference (i.e., 0% Fe added).

The reference sample prepared without added iron had a specific surface area of only 40 m²/g.

### Example 8

The pigment obtained as in Example 1 was coated as follows:

8.3 kg of moist presscake (23% solids) were homogenized in 29 kg of water, heated to about 95° C., then adjusted to pH 6.1, and subsequently stirred for about 30 minutes.

This was followed by the addition of 12.0 kg of a hot aqueous emulsion at about 95° C., which contained 4.9% of stearic acid and 2.9% by weight of an anionic surfactant based on an ethoxylated sulfated fatty alcohol and had been adjusted to pH 6.4 with hydrochloric acid, and subsequent stirring at 95° C. for 180 minutes.

The suspension thus obtained was bulked with water to 88 liters and filtered with suction, and the filter residue was washed with hot water at about 70° C. until a conductivity of less than 200 μSi/cm was obtained.

This provided a water-moist pigment presscake having a solids content of 40.5% by weight. This presscake was oven dried at 70° C. to a residual moisture content of less than 1% by weight and finely ground by means of a cutting mill to form the solid pigment preparation to be used according to the invention.

The coated pigment powder was incorporated into PVC by cold milling on a roll mill.

The color strength rose to 110% when instead of the pigment of Example 1 the pigment of Example 4 was coated as above (75 ppm of Fe).

### Example 9

5 kg of a suspension of the potassium salt of azobarbituric acid (12.5% by weight), 1,970 g of 24.9% NiCl₂.6H₂O solution, 504 g of melamine, and 0.58 g of FeSO₄.7H₂O were mixed, ground using a Cavitron, and bulked to 10 liters with deionized water.

The mixture was passed through a continuous reactor as described for example in DE-A 100 135 47 at a flow rate of 6 kg/h.

The reaction temperature was 115° C. and the residence time was 4 minutes. The suspension obtained was adjusted to pH 4.8 with potassium acetate solution (25%). This was followed by filtration, washing, drying under reduced pressure, grinding, and incorporation into a white paint according to DIN a53 238 Part 31.

The specific surface area was 150 m²/g and a color strength of 125% is achieved.

What is claimed is:

1. A solid pigment preparation comprising
(a) as pigment at least one metal complex of an azo compound that in the form of its tautomeric structures conforms to the formula (I) 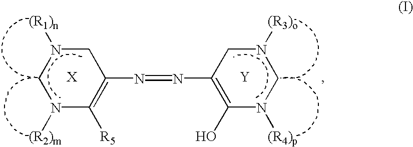
wherein
the X and Y rings independently are optionally substituted with one or two substituents selected from the group consisting of ═O, ═S, ═NR₇, —NR₆H₇, —OR₆, —SR₆, —COOR₆, —CN, —CONR₆R₇, —SO₂R₈, 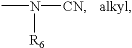
cycloalkyl, aryl, and aralkyl,
the dotted lines in each of the rings X and Y optionally represent one or two double bonds such that the total number of endo- and exocyclic double bonds is three for each of the X and Y rings,
R₁, R₂, R₃, and R₄ are independently hydrogen, alkyl, cycloalkyl, aryl, or aralkyl, or R₁ and R₂ together and/or R₃ and R₄ together form 5- or 6-membered rings, as indicated by the broken lines, to which further rings can optionally be fused,
m, n, o, and p are 1 when the corresponding ring nitrogen atom is not part of a double bond or are zero when the corresponding ring nitrogen atom is part of a double bond, as indicated by the dotted lines,
R₆ is hydrogen, alkyl, cycloalkyl, aryl, or aralkyl,
R₇ is hydrogen, cyano, alkyl, cycloalkyl, aryl, aralkyl, or acyl,
R₈ is alkyl, cycloalkyl, aryl, or aralkyl,
R₅ is —OH, —NR₆R₇, alkyl, cycloalkyl, aryl, or aralkyl,
with the proviso that R₁ to R₈ are optionally further substituted by replacing the hydrogen atom of a CH group, and
(b) at least one guest compound,
wherein the metal complex that hosts at least one other compound contains at least 30 ppm of Fe, based on the sum total of metal complex and guest compound.

2. A pigment preparation according to claim 1 wherein the metal complex that hosts at least one other compound contains 30 to 2,000 ppm of Fe, based on the sum total of metal complex and guest compound.

3. A pigment preparation according to claim 1 comprising at least two metal complexes of an azo compound that in the form of its tautomeric structure conforms to the formula (I) that each host at least one other compound, the metal of one of the metal complexes being Fe wherein the Fe content, based on the sum total of metal complexes and guest compounds, is at least 30 ppm.

4. A pigment preparation according to claim 1 wherein the X ring represents a ring of the formula 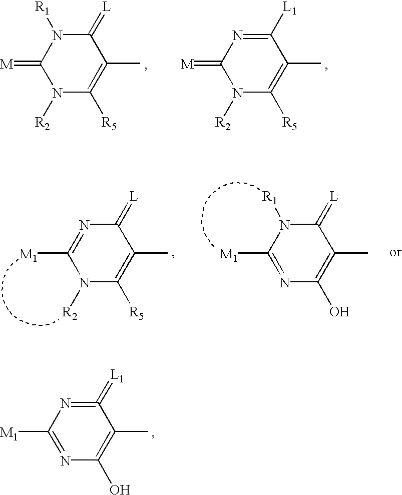
wherein
L and M are each independently ═O, ═S, or ═NR₆,
L₁ is hydrogen, —OR₆, —SR₆, —NR₆R₇, —COOR₆, —CONR₆R₇, —CN, alkyl, cycloalkyl, aryl, or aralkyl,
M₁ is —OR₆, —SR₆, —NR₆R₇, —COOR₆, —CONR₆R₇, —CN, —SO₂R₈, 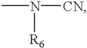
alkyl, cycloalkyl, aryl, or aralkyl, or the substituents M₁ and R₁ or M₁ and R₂ may form a 5- or 6-membered ring, and
R₁, R₂, and R₅ are each as defined for formula (I).

5. A pigment preparation according to claim 1 wherein the azo compound of the formula (I) conforms in the form of its free acid to the formula (II) or (III) or one of its tautomeric formulas 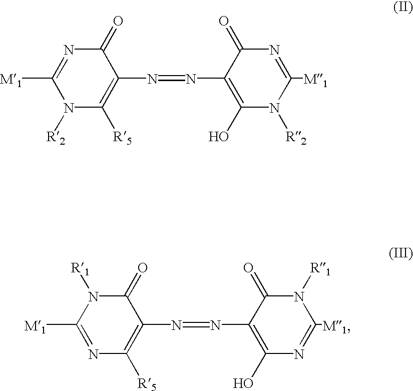
wherein
R′₅ is —OH or —NH₂,
R′₁, R″₁, R′₂, and R″₂ are each hydrogen, and
M′₁ and M″₁ are independently hydrogen, —OH, —NH₂, —NHCN, arylamino, or acylamino.

6. A pigment preparation according to claim 1 wherein the azo compound of the formula (I) conforms to the formula (V) or a tautomeric form thereof

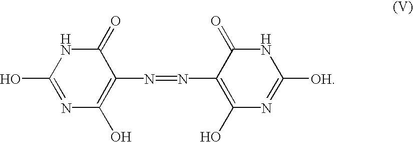

7. A pigment preparation according to claim 1 wherein the metal complexes of the azo compound of formula (I) are salts or complexes of mono-, di-, tri-, and tetraanions of the azo compounds of the formula (I) with metals selected from the group consisting of Li, Na, K, Mg, Ca, Ba, Fe, Co, Ni, Zn, Cu, Mn, Al, La, and Cr.

8. A pigment preparation according to claim 1 wherein the metal complex is a Ni salt or complex of the azo compound of the formula (I).

9. A pigment preparation according to claim 1 wherein the metal complex hosts a cyclic or acyclic organic compound.

10. A pigment preparation according to claim 1 wherein the metal complex hosts melamine.

11. A process for producing a pigment preparation according to claim 1 comprising
(a) complexing and azo compound of the formula (I) with a non-iron metal salt in the presence of a sufficient amount of an iron salt to provide an iron content of at least 30 ppm, based on the sum total of metal complex and guest compound, thereby forming a metal complex, and
(b) reacting the resultant metal complex with a host compound.

12. A method for preparing printing colors, distemper colors, or binder colors comprising adding a pigment preparation according to claim 1 to a varnish.

13. A method for mass coloring synthetic, semisynthetic, or natural macromolecular substances comprising introducing a pigment preparation according to claim 1 into a synthetic, semisynthetic, or natural macromolecular substance.

14. A method for spin-dyeing natural, regenerated, or artificial fibers comprising applying a dye composition containing a pigment preparation according to claim 1 to a natural, regenerated, or artificial fiber during the fiber spinning process.

15. A method for printing textiles or paper comprising applying a printing preparation containing a pigment preparation according to claim 1 to a textile or paper.
